(19) United States
(12) Patent Application Publication
(10) Pub. No.: US 2026/0164401 A1
(43) Pub. Date: Jun. 11, 2026

(54) SUBSCRIBER IDENTITY MODULE LOCATION SERVICE

(71) Applicant: T-MOBILE INNOVATIONS LLC, Overland Park, KS (US)

(72) Inventors: Kulandaivel MARAPPA GOUNDER, Bothell, WA (US); Kyeong Hun AN, Sammamish, WA (US); Nilesh RANJAN, Sammamish, WA (US)

(21) Appl. No.: 18/973,930

(22) Filed: Dec. 9, 2024

(51) Int. Cl. H04W 64/00; H04W 24/08

(52) U.S. Cl. CPC H04W 64/006; H04W 24/08

(57) ABSTRACT

Embodiments of the present disclosure are directed to systems and methods for obtaining accurate and secure location information in mobile communication networks. By implementing a subscriber identity module (SIM) applet capable of interacting with the user device and external servers, the disclosed methods and systems ensure that precise location data can be collected, processed, and utilized for various applications. These outcomes are achieved through a method where the SIM applet requests network measurement reports (NMRs) and cell site location information (CGI) to triangulate the device's location, providing this data to external servers for real-time location services.

### SUMMARY

The present disclosure is directed, in part, to methods and systems for enhancing location-based services in mobile communication devices through the use of a subscriber identity module (SIM) applet, substantially as shown and/or described in connection with the figures. This disclosure provides innovative mechanisms for utilizing a SIM applet to request and process location data, thereby enabling advanced location-based functionalities.

According to various aspects of the technology, the disclosed methods introduce solutions to the problem of obtaining accurate and secure location information in mobile communication networks. By implementing a SIM applet capable of interacting with the user device and external servers, the disclosed methods and systems ensure that precise location data can be collected, processed, and utilized for various applications. These outcomes are achieved through a method where the SIM applet requests network measurement reports (NMR) and cell global identity (CGI) data to triangulate the device's location, providing this data to external servers for real-time location services. This method and system leverages the capabilities of SIM applets to provide secure, accurate, and efficient location-based services.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an exemplary network environment in which implementations of the present disclosure may be employed;

FIG. 4 illustrates an exemplary network environment in which implementations of the present disclosure may be employed; and

FIG. 5 illustrates a flow diagram of an exemplary method for determining the location of a user device using a SIM.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Modern communication networks rely heavily on precise and secure location-based services to provide users with accurate positioning, navigation, and various location-dependent applications. A critical component in enabling these services is the SIM card, which can be enhanced to collect and transmit location data securely and efficiently. Users of mobile networks often require real-time and historical location data for purposes such as navigation, tracking, emergency services, and business analytics.

As used herein, “network measurement reports (NMR)” may refer to a report generated by a user device that provides metrics on signal quality and performance for the serving cell and neighboring cells. The NMR may include measurements such as received signal strength (RSSI) and signal-to-noise ratios. These reports may be generated periodically or in response to network requests.

As used herein, “cell global identity (CGI)” may refer to a unique identifier assigned to a cell in a network. CGI may include a structured code that helps networks and devices identify specific cells, which may support functions such as call routing and handover management. CGI may comprise several components such as the Mobile Country Code (MCC), the Mobile Network Code (MNC), the Location Area Code (LAC), and/or the Cell Identity (CI), which may be used to identify cell-level locations within communications networks.

As used herein, “SIM applet” may refer to an application installed on a SIM card within a user device. A SIM applet may run directly on the SIM card's secure, embedded environment, which helps enable them to perform tasks independently from the device's operating system. SIM applets may manage a range of activities such as authentication, providing secure storage for cryptographic keys, facilitating secure transactions, and interacting with the network through SIM Application Toolkit (SAT) commands. SIM applets may also help support functions like secure messaging, network-based authentication, and/or location-based services.

Conventionally, obtaining accurate and secure location data has been challenging due to reliance on external applications or additional hardware. These methods often lack the integration and security features provided by SIM-based solutions. Existing solutions do not leverage the potential of the SIM card to serve as a central hub for collecting and transmitting location data. As a result, there is a gap in the ability to provide seamless, secure, and integrated location-based services directly from the SIM, leading to inefficiencies, potential security risks, and the need for multiple systems to work in tandem to provide comprehensive location services.

In contrast to conventional solutions, the present disclosure provides an innovative method that leverages the capabilities of a SIM applet to enhance location-based services. The disclosed method includes a SIM applet that requests NMRs and CGI from the user device to triangulate the device's location. This data is securely transmitted to external servers, enabling accurate real-time location services. By utilizing the SIM applet for this purpose, the invention ensures that location data is collected and transmitted securely, enhancing overall network integrity and providing valuable insights for various applications.

Accordingly, a first aspect of the present disclosure provides a system for determining the location of a user device is provided. This system comprises one or more computer processing components configured to perform specific operations designed to accurately locate the user device within a mobile communication network. The operations begin with receiving, by an application installed on a SIM within the user device, a request from a network for the location of the user device. Upon receiving this location request, the SIM application prepares to process the request by engaging with the user device's internal components and network interfaces. The next operation involves requesting, from the user device by the application, one or more NMR and one or more CGI for each cell site that the user device is attached to. These NMRs include signal measurements such as received signal strength indicator (RSSI), reference signal received power (RSRP), and signal-to-noise ratio (SNR), while CGIs provide the identification of the specific locations of the cell sites. Following this, the system determines the location of the user device using a triangulation algorithm that processes the one or more NMRs and the one or more CGIs. The triangulation algorithm analyzes the signal measurements and computes the distances between the user device and the cell sites based on the NMRs and CGIs. Finally, the system communicates the location of the user device to an external server, ensuring that the location information is securely transmitted to the network or service provider requesting it.

In a second aspect of the present disclosure, a method for determining the location of a user device is provided. This method comprises a sequence of steps that the SIM performs to accurately locate the user device within a mobile communication network. The method begins with receiving, by an application installed on a SIM within the user device, a request from a network for the location of the user device. The SIM application acknowledges the request and prepares to collect the required data from the user device. The next step involves requesting, from the user device by the application, one or more NMRs and one or more CGIs for each cell site that the user device is attached to. The user device collects signal measurements (RSSI, RSRP, SNR) from all connected cell sites and retrieves the CGIs for each cell site, identifying their specific locations. Upon receiving the NMRs and CGIs, the method proceeds to determine the location of the user device using a triangulation algorithm. The triangulation algorithm processes the received NMRs and CGIs to calculate the location of the user device by analyzing the signal measurements, computing distances, and determining the intersection point of the computed distances. Finally, the method involves communicating the determined location of the user device to an external server, ensuring that the location information is securely delivered to the network or service provider requesting it.

Another aspect of the present disclosure is directed to a non-transitory computer-readable medium having instructions stored thereon that, when executed by one or more computer processing components, cause the one or more computer processing components to perform a method for determining the location of a user device. The method comprises several key steps designed to accurately locate the user device within a mobile communication network. The method begins with receiving, by an application installed on a SIM within the user device, a request from a network for the location of the user device. Upon receiving the location request, the SIM application prepares to process the request by engaging with the user device's internal components and network interfaces. The next step involves requesting, from the user device by the application, one or more NMR and one or more CGI for each cell site that the user device is attached to. The user device collects signal measurements (RSSI, RSRP, SNR) from all connected cell sites and retrieves the CGIs for each cell site, identifying their specific locations. The method then proceeds to determine the location of the user device using a triangulation algorithm that processes the received NMRs and CGIs. The triangulation algorithm analyzes the signal measurements, computes distances, and determines the intersection point of the computed distances to pinpoint the location of the user device. Finally, the method involves communicating the determined location of the user device to an external server, ensuring that the location information is securely transmitted to the network or service provider requesting it.

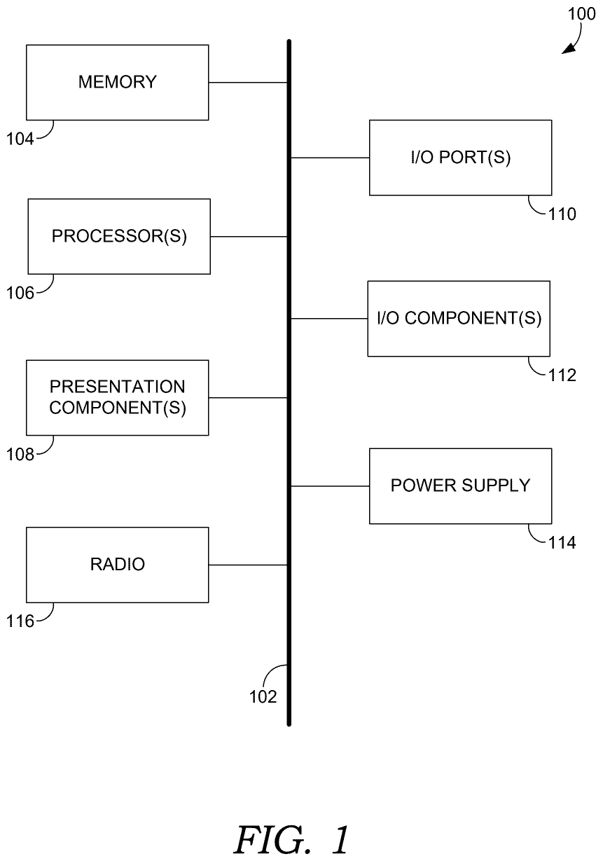

Referring to the drawings in general, and initially to FIG. 1, an exemplary computing environment 100 suitable for practicing embodiments of the present technology is provided. Computing environment 100 is just one example, and is not intended to suggest any limitation as to the scope of use or functionality of the embodiments discussed herein. Furthermore, the computing environment 100 should not be interpreted as having any dependency or requirement relating to any one or a combination of components illustrated. It should be noted that although some components in FIG. 1 are shown in the singular, they might be plural. For example, the computing environment 100 might include multiple processors and/or multiple radios. As shown in FIG. 1, computing environment 100 includes a bus 102 that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 may take the form of memory components described herein. Thus, further elaboration will not be provided here, but it should be noted that memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. Processor 106 may actually be multiple processors that receive instructions and process them accordingly. Presentation component 108 may include a display, a speaker, and/or other components that may present information (e.g., a display, a screen, a lamp (LED), a graphical user interface (GUI), and/or even lighted keyboards) through visual, auditory, and/or other tactile cues.

Radio 116 may facilitate communication with a network, and may additionally or alternatively facilitate other types of wireless communications, such as Wi-Fi, WiMAX, LTE, and/or other VoIP communications. In various embodiments, the radio 116 may be configured to support multiple technologies, and/or multiple radios may be configured and utilized to support multiple technologies. The input/output (I/O) ports 110 may take a variety of forms. Exemplary I/O ports may include a USB jack, a stereo jack, an infrared port, a firewire port, other proprietary communications ports, and the like. Input/output (I/O) components 112 may comprise keyboards, microphones, speakers, touchscreens, and/or any other item usable to directly or indirectly input data into the computing environment 100. Power supply 114 may include batteries, fuel cells, and/or any other component that may act as a power source to supply power to the computing environment 100 or to other network components, including through one or more electrical connections or couplings. Power supply 114 may be configured to selectively supply power to different components independently and/or concurrently.

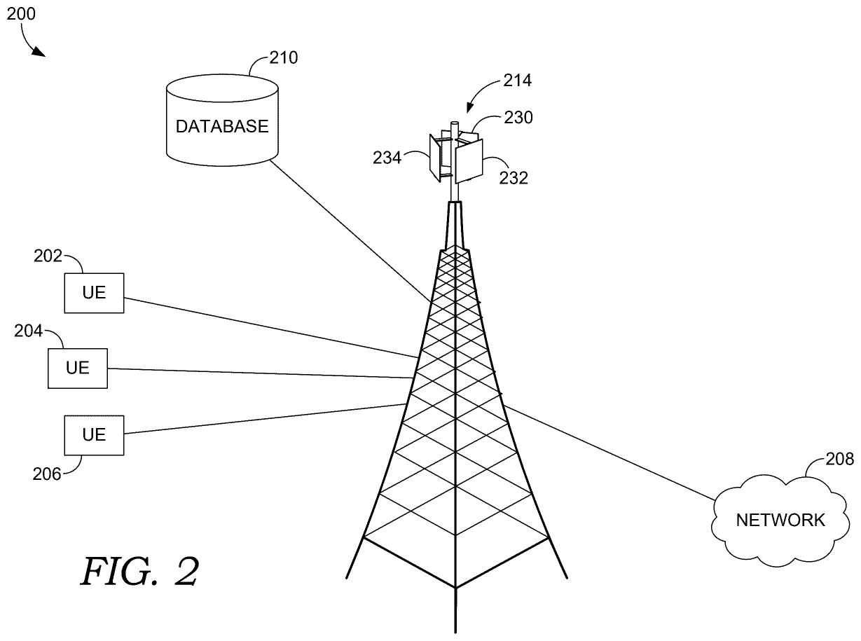

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, and database 210. In network environment 200, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, 6G, CDMA, or any other type of network.

In other aspects, the user devices 202, 204, and 206 encompass a diverse range of high-throughput and high data consumption devices, catering to various user needs and environments. The first device, 202, corresponds to a Home Internet Network Terminal (HINT). Device 204 represents a Fixed Wireless Access (FWA) device, which provides internet access in areas where wired connectivity is limited or unavailable.

Additionally, the user devices 202, 204, and 206 can be any device characterized by high data throughput needs, such as advanced gaming consoles that require rapid data exchange for real-time multiplayer experiences, or professional-grade video conferencing systems used in businesses for high-quality virtual meetings. This category also includes emerging Internet of Things (IoT) devices, like intelligent security cameras and smart home appliances, which constantly transmit and receive data for automation and monitoring purposes. Furthermore, high-performance tablets and laptops also fall under this category, as they require high-speed internet for cloud computing and large file transfers.

In some cases, the user devices 202, 204, and 206 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE, 4G, 5G, 6G) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1x circuit voice, a 3G network (e.g., CDMA, CDMA2000, WCDMA, GSM, UMTS), a 4G network (WiMAX, LTE, HSDPA), a 5G network, or a 6G network. The network 208 may also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited coverage area. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 may comprise multiple base stations and/or multiple transmit antennas for each of the one or more base stations, any one or more of which may serve at least a portion of the cell. For example, the cell site may comprise a first antenna array 230, a second antenna array 232, and a third antenna array 234, wherein each of the antenna arrays serves a distinct sector (i.e., portion) of the coverage area of the cell 214. In some aspects, the cell site 214 may comprise one or more macro cells (providing wireless coverage for users within a large geographic area) or it may be a small cell (providing wireless coverage for users within a small geographic area).

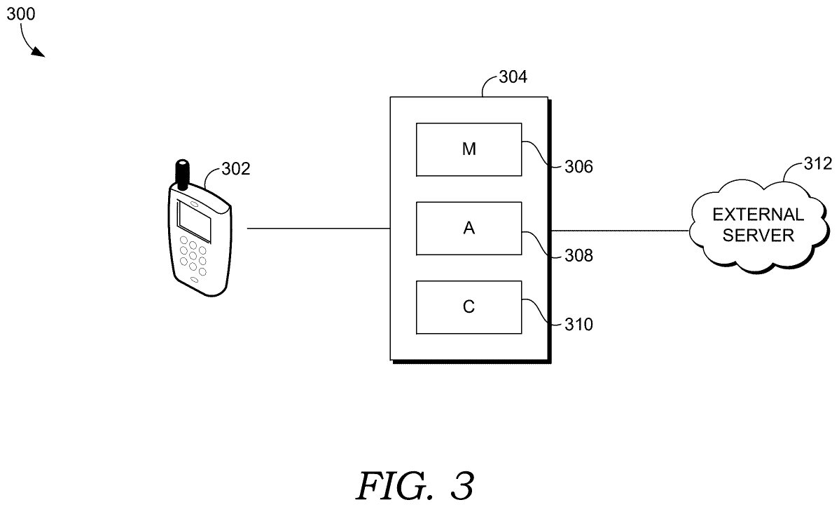

FIG. 3 provides an exemplary network environment in which implementations of the present disclosure may be employed. Such a network environment is illustrated and designated generally as network environment 300. Network environment 300 is but one example of a suitable network environment and is not intended to suggest any limitation as to the scope of use or functionality of the invention. Neither should the network environment be interpreted as having any dependency or requirement relating to any one or combination of components illustrated. The network environment 300 includes a UE 302 that is capable of operating in network environment 200. The network environment 300 additionally comprises one or more hardware and/or software components that, together, make up a SIM applet 304 installed on the SIM within the UE 302. The SIM applet 304 may comprise a monitor 306, an analyzer 308, and/or a controller 310.

The monitor 306 may be responsible for receiving requests from the network for the location of the UE 302. Upon receiving such a request, the monitor 306 may request from the UE 302 one or more NMR and one or more CGI for each cell site to which the UE 302 is attached. These NMRs may include signal measurements such as RSSI, RSRP, and SNR. The CGIs may provide the identification of the specific locations of the cell sites. The process may begin with the network initiating a location request to determine the current location of the UE 302. The SIM applet may receive this request through the monitor 306, which may then engage with the UE 302 to collect the required data.

Additionally or alternatively, the monitor 306 may periodically requests NMRs and CGIs at predefined intervals to update the location of the UE 302. These predefined intervals may be dynamically adjusted based on the movement speed of the UE 302, ensuring accurate and timely updates of the location information. Such a periodic request mechanism helps allow the SIM applet to continuously monitor the location of the UE 302 and provide real-time updates. The intervals can be configured based on various factors, including the speed of movement and the specific requirements of the network or service provider.

The analyzer 308 may process the received NMRs and CGIs using a triangulation algorithm to determine the location of the UE 302. This triangulation algorithm calculates the location of the UE 302 by analyzing the signal measurements for each cell site, computing distances between the UE 302 and each of the cell sites based on the signal measurements and the CGIs, and determining an intersection point of the computed distances to pinpoint the location of the UE 302. The triangulation algorithm involves several key steps. First, it may analyze the signal measurements (RSSI, RSRP, SNR) for each cell site to assess the strength and quality of the signals. These measurement may be helpful for determining the relative distance between the UE 302 and each cell site. Second, the algorithm may compute the distances between the UE 302 and the cell sites based on the signal measurements and the CGIs. The distances may be calculated using known propagation models and signal attenuation formulas that relate signal strength to distance. Finally, the algorithm may determine an intersection point of the computed distances to accurately estimate the location of the UE 302.

In some embodiments, the analyzer 308 may validate the received CGIs against a database of known cell sites to ensure the accuracy of the location determination. The analyzer 308 may also employ machine learning techniques to refine the accuracy of the location determination over time based on historical location data. The validation process may involve comparing the received CGIs with a database of known cell sites to confirm their authenticity and accuracy. The use of machine learning techniques allows the system to learn from historical data and improve the precision of the location determination algorithm.

The controller 310 helps manage the overall operation of the SIM applet 304, including the secure communication of the determined location to an external server 312. The controller 310 may use a secure communication protocol such as TLS/SSL to transmit the location data to the external server 312, helping ensure the privacy and security of the location information. This step helps ensure that the location information is securely delivered to the network or service provider requesting it, maintaining the confidentiality and integrity of the transmitted data. The secure transmission helps prevent unauthorized access and ensures that the location data is only accessible to authorized entities.

The controller 310 may further include a mechanism for generating an alert on the UE 302 indicating that a location request has been processed. This alert informs the user that the location of the UE 302 has been determined and communicated to the network. The alert mechanism helps provide transparency to the user and ensures that they are aware of the location determination process.

The controller 310 may store the NMRs and CGIs temporarily within the SIM before being transmitted to the external server 312. This secure storage mechanism helps protect the data from unauthorized access and ensures that the location information is only available to authorized entities. The temporary storage of NMRs and CGIs within the SIM provides an additional layer of security and prevents unauthorized access to sensitive location data.

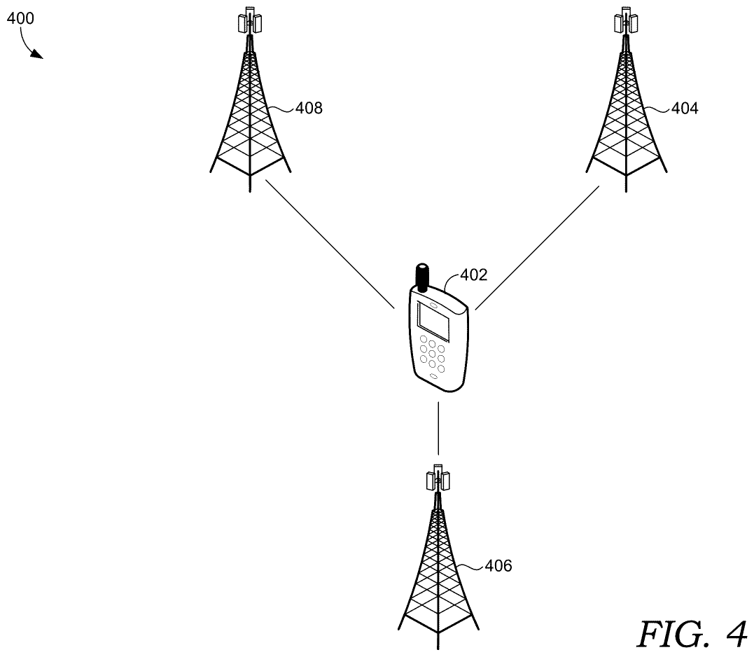

FIG. 4 provides an exemplary network environment in which implementations of the present disclosure may be employed. This network environment is illustrated and designated generally as network environment 400. Network environment 400 is but one example of a suitable network environment and is not intended to suggest any limitation as to the scope of use or functionality of the invention. Neither should the network environment be interpreted as having any dependency or requirement relating to any one or combination of components illustrated.

Network environment 400 may include a UE 402, a first cell site 404, a second cell site 406, and a third cell site 408. The UE 402 may be capable of operating within the network environment 400 and communicating with multiple cell sites. Each cell site represents a network providing wireless communication coverage to the UE 402. These cell sites may be part of a larger cellular network infrastructure that facilitates the transmission and reception of data.

The UE 402 can connect to multiple cell sites, allowing it to maintain optimal connectivity and ensure seamless communication. When the UE 402 moves within the network environment 400, it constantly evaluates signal strengths from various cell sites to determine the best possible connection. This process, known as handover or cell reselection, ensures that the UE 402 remains connected to the network with the highest signal quality and lowest interference.

In one embodiment, the UE 402 may receive a request from the network for its location. This request may be processed by the SIM applet (e.g., applicaton) installed on the SIM within the UE 402. The SIM applet may then request NMRs and CGIs from the UE 402. The NMRs may include signal measurements such as RSSI, RSRP, and SNR from the first cell site 404, second cell site 406, and third cell site 408. The CGIs may provide the identification of the specific locations of these cell sites. The SIM applet may then process the NMRs and CGIs using a triangulation algorithm to determine the location of the UE 402. This may involve analyzing the signal measurements and computing distances between the UE 402 and each cell site. The triangulation algorithm may then determine the intersection point of the computed distances to pinpoint the location of the UE 402. The controller component of the SIM applet securely communicates the determined location to an external server (e.g., external server 312).

The SIM applet periodically requests NMRs and CGIs from the UE 402. This periodic request is dynamically adjusted based on the movement speed of the UE 402. As the UE 402 moves within the network environment 400, the frequency of these requests may increase to provide more accurate and timely location updates. This ensures that the location information remains current and reliable. The SIM applet validates the received CGIs against a database of known cell sites. In the network environment 400, the CGIs from the first cell site 404, second cell site 406, and third cell site 408 are compared against the database to ensure their accuracy. This validation process enhances the reliability of the location determination by confirming that the CGIs correspond to legitimate cell sites.

The SIM applet can, in one embodiment use machine learning techniques to refine the accuracy of the location determination over time based on historical location data. In the network environment 400, the historical NMR and CGI data collected from the UE 402 interacting with the first cell site 404, second cell site 406, and third cell site 408 are used to train the machine learning models.

In some aspects, the SIM applet may generate an alert on the UE 402 indicating that a location request has been processed. This alert mechanism informs the user that the location of the UE 402 has been determined and communicated to the network. The alert may be generated whenever the SIM applet processes a location request from the network, ensuring that the user is aware of the location determination process. The SIM applet may encrypt the location data before transmitting it to the external server. In the network environment 400, the encrypted location data may be securely sent over the communication links to prevent unauthorized access. The secure transmission helps ensure that the location information remains confidential and protected from potential security threat.

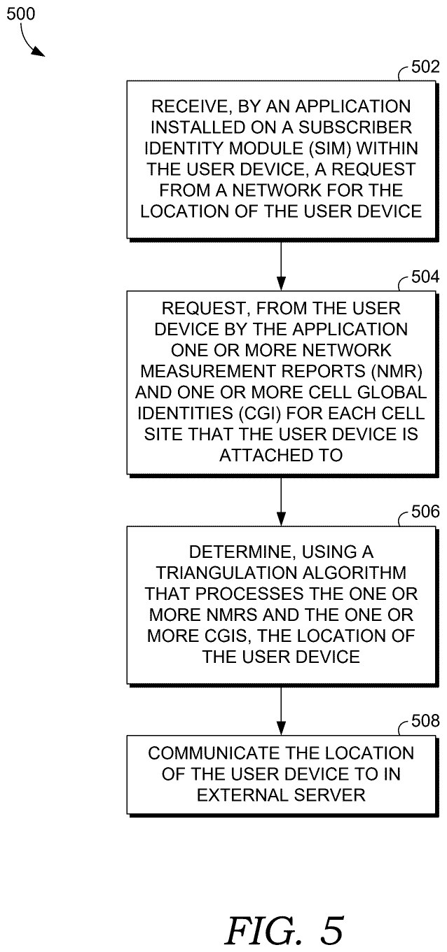

Turning now to FIG. 5, a flow chart is provided that illustrates one or more aspects of the present disclosure relating to a method 500 for determining the location of a user device. The method 500 begins at block 502 with the initiation of a location request session by an application installed on a SIM within the user device. This initial step involves the SIM receiving a request from the network for the location of the user device. The request typically originates from a network server or an external application that requires the current location of the user device for various purposes, such as location-based services or network optimization. Upon receiving this location request, the SIM application prepares to process the request by engaging with the user device's internal components and network interfaces. This preparation includes initializing the necessary protocols and communication channels to facilitate data exchange between the SIM, the user device, and the network.

At block 504, the SIM application requests from the user device one or more NMR and one or more CGI for each cell site that the user device is attached to. This step involves the SIM application sending a command to the user device to collect and return the required NMRs and CGIs. The NMRs include various signal measurements such as RSSI, RSRP, and SNR. These signal measurements provide critical information about the quality and strength of the signals received by the user device from different cell sites. The CGIs, on the other hand, provide the identification of the specific locations of the cell sites. Each CGI is a unique identifier associated with a cell site, allowing the network to pinpoint the exact geographical location of the cell site. The user device collects the NMRs and CGIs by measuring the signals from all the cell sites it is connected to and retrieving the corresponding identifiers.

Upon receiving the NMRs and CGIs from the user device, the method proceeds to block 506, where the SIM application determines the location of the user device using a triangulation algorithm. This algorithm processes the collected NMRs and CGIs to calculate the location of the user device. The triangulation algorithm involves several steps. Firstly, it analyzes the signal measurements (RSSI, RSRP, SNR) for each cell site to assess the strength and quality of the signals. Secondly, the algorithm computes the distances between the user device and the cell sites based on the signal measurements and the CGIs. The distances are calculated using known propagation models and signal attenuation formulas that relate signal strength to distance. Finally, the algorithm determines an intersection point of the computed distances to pinpoint the location of the user device. By considering the signal strength and location data from multiple cell sites, the algorithm enhances the accuracy of the location determination. The use of multiple cell sites and signal measurements helps to mitigate the effects of signal interference and multipath propagation, leading to a more reliable location estimate.

At block 508, the method involves communicating the determined location of the user device to an external server. The SIM application packages the location data securely and uses a secure communication protocol such as TLS/SSL to transmit the data to the external server. This step ensures that the location information is securely delivered to the network or service provider requesting it, maintaining the confidentiality and integrity of the transmitted data. The secure transmission prevents unauthorized access and ensures that the location data is only accessible to authorized entities. The external server, upon receiving the location data, can use it for various applications such as providing location-based services, enhancing network performance, or supporting emergency services. The secure and accurate communication of location data is critical for maintaining the trust and reliability of the mobile communication network

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for determining a location for a user device, the method comprising:
receiving, by an application installed on a subscriber identity module (SIM) within the user device, a request from a network for the location of the user device;
requesting from the user device, by the application, one or more network measurement reports (NMRs) and one or more cell site location information (CGIs) for each cell site of a plurality of cell sites that the user device is attached to;
determining, based on the one or more NMRs and the one or more CGIs, the location of the user device; and
communicating the location of the user device to an external server.

2. The method of claim 1, wherein each of the one or more NMRs comprise one or more signal measurements for each cell site that the user device is attached to.

3. The method of claim 1, wherein each of the one or more CGIs comprise an identification of a specific location for each cell site that the user device is attached to.

4. The method of claim 1, wherein the location is determined using a triangulation algorithm, wherein the triangulation algorithm calculates the location by:
analyzing one or more signal measurements for each of the one or more NMRs for each cell site that the user device is attached to;
computing a distance between the user device and each of cell site that the user device is attached to based on the one or more NMRs and the one or more CGIs; and
determining an intersection point of the distance to identify the location.

5. The method of claim 1, wherein the one or more NMRs include one or more of the following: a received signal strength indicator (RSSI), a reference signal received power (RSRP), and a signal-to-noise ratio (SNR).

6. The method of claim 1, further comprising requesting the one or more NMRs and the one or more CGIs at predefined intervals to update the location of the user device.

7. The method of claim 6, wherein the predefined intervals are dynamically adjusted based on a movement speed of the user device.

8. The method of claim 1, further comprising validating the one or more CGIs against a database of known cell sites.

9. The method of claim 1, wherein determining the location comprises a machine learning algorithm to refine an accuracy of determining the location over time based on one or more historical locations.

10. The method of claim 1, further comprising generating an alert on the user device indicating that a location request has been processed by the application on the SIM.

11. The method of claim 1, wherein the application stores the one or more NMRs and the one or more CGIs for a predetermined period before transmitting the location to the external server.

12. A system for determining a location for a user device, the system comprising:
the user device configured to communicate with one or more cell sites associated with a network;
a subscriber identity module (SIM) installed within the user device, the SIM comprising an application configured to:
receive a request from the network for the location of the user device;
request one or more network measurement reports (NMRs) and one or more cell site location information (CGI) from the user device;
determine the location of the user device based on the one or more NMRs and the one or more CGIs; and
provide the location of the user device to an external server.

13. The system of claim 12, wherein the one or more NMRs comprise one or more of: a received signal strength indicator (RSSI), a reference signal received power (RSRP), and a signal-to-noise ratio (SNR).

14. The system of claim 12, further comprising a secure communication protocol, such as TLS/SSL, used by the SIM to transmit the location to the external server.

15. The system of claim 12, wherein the application is configured to validate the one or more CGIs against a database of known cell sites.

16. A subscriber identity module (SIM) for determining a location of a user device, the SIM comprising:
an application installed on the SIM, the application configured to:
receive a request from a network for the location of the user device;
request one or more network measurement reports (NMRs) and one or more cell site location information (CGIs) from the user device;
determine the location of the user device based on the one or more NMRs and the one or more CGIs;
encrypt the location; and
transmit the location to an external server.

17. The SIM of claim 16, wherein the application periodically requests the one or more NMRs and the one or more CGIs at predefined intervals to update the location of the user device.

18. The system of claim 16, wherein the location is calculated by analyzing one or more signal measurements within the one or more NMRs and computing distances between the user device and one or more cell towers based on a signal strength and the one or more CGIs.

19. The system of claim 16, wherein the application generates an alert on the user device indicating that a location request has been processed.

20. The SIM of claim 16, further comprising a secure storage mechanism within the SIM for temporarily storing the one or more NMRs and the one or more CGIs before transmitting the location to the external server.
